(19) United States
(12) Patent Application Publication
(10) Pub. No.: US 2025/0217215 A1
(43) Pub. Date: Jul. 3, 2025

(54) DYNAMICALLY GENERATING OPTIMIZED APPLICATION PROGRAMMING INTERFACES

(71) Applicant: TEACHERS INSURANCE AND ANNUITY ASSOCIATION OF AMERICA, New York, NY (US)

(72) Inventors: Daniel Ray Hursh, Dayton, OH (US); Sheppard David Narkier, Charlotte, NC (US)

(21) Appl. No.: 18/402,085

(22) Filed: Jan. 2, 2024

(51) Int. Cl. G06F 9/54

(52) U.S. Cl. CPC G06F 9/547

(57) ABSTRACT

Systems and methods for dynamically generating optimized application programming interfaces (APIs) using artificial intelligence (AI). The system may include an API database storing API data of a plurality of APIs of an API platform, and a generative AI model trained to generate an optimized API having at least a portion of the operational characteristics of one or more APIs of the API platform. The system may obtain an API call data stream of API calls from a user device to the APIs, and analyze the API call data stream to generate user-specific API transaction data. The generative AI model may receive the user-specific API transaction data and the API data to determine, and generate the optimized API. The system may configure the optimized API for execution, and provide the optimized API for execution by a user of the API platform.

### FIELD OF THE INVENTION

The present disclosure generally relates to systems and methods involving application programming interfaces (APIs), and more particularly, to systems and methods for dynamically generating optimized APIs for an API platform using artificial intelligence (AI).

### BACKGROUND

Modern software ecosystems depend on the integration of technology and services from multiple providers. While the providers may allow access to their respective services via one or more APIs, differing requirements from system to system, or even worse API to API, to access the services may cause development of APIs for the ecosystem to be both cost and time prohibitive. Even if attempting to reuse any of the numerous APIs supported by an API platform of the ecosystem to provide a customized and/or optimized API in a more efficient manner as compared to creating one from scratch, understanding the operational characteristic of the existing APIs which may be suitable for reuse may be implausible, if not impossible.

The conventional techniques for generating optimized APIs from a collection of APIs which may be suitable for a particular use may include additional ineffectiveness, inefficiencies, encumbrances, and/or other drawbacks.

Accordingly, there is a need for systems and methods for dynamically generating optimized APIs for an API platform.

### SUMMARY

The present embodiments may relate to, inter alia, systems and methods for dynamically generating optimized APIs for an API platform using AI.

In one embodiment, an AI-based system for based system for dynamically generating APIs. The system may include an API database storing API data of a plurality of APIs of an API platform, wherein the API data may indicate one or more operational characteristics of one or more APIs of the plurality of APIs. The system may include a generative AI model stored on one or more memories and executable by one or more processors, wherein the generative AI model may be trained using training data to generate an optimized API having at least a portion of the one or more operational characteristics of the one or more APIs. The system may include a set of computer-executable instructions stored on the one or more memories that when executed by the one or more processors may cause the system processors to: (i) obtain an API call data stream of one or more API calls from a user device to the plurality of APIs; (ii) analyze the API call data stream to generate user-specific API transaction data corresponding to the one or more API calls, the user-specific API transaction data may indicate information exchanged between the user device and the plurality of APIs during the one or more API calls; (iii) execute the generative AI model to: (a) receive the user-specific API transaction data and the API data; and (b) generate, based on the API transaction data and the API data, the optimized API; and (iv) update the API platform to implement the optimized API, wherein the API platform is configured to receive and respond to calls from one or more client devices. The system may include additional, less, or alternate functionality, including those discussed elsewhere herein.

In one aspect of the system, the API data may include one or more of a method, a function, an endpoint, an action, a request parameter, a data format, a use case, a security characteristic, or a response.

In another aspect of the system, the training data may include historical transaction data and historical API data.

In yet another aspect of the system, the historical transaction data and/or historical API data may be defined by one or more API class types.

In yet another aspect of the system, the generative AI model may include a large language model (LLM).

In still yet another aspect of the system, the generative AI model may include GraphQL.

In another aspect of the system, the optimized API may be based upon the one or more APIs and may include one or more of: one or more new functions not provided by the one or more APIs, or one or more reconfigured functions of the one or more APIs.

In yet another aspect of the system, the system may include stored instructions that, when executed by the one or more processors, may further cause the system to execute one or more tests of the optimized API using historical API traffic data, wherein the optimized API may be configured for execution based upon the optimized API achieving at least a metric during the one or more tests.

In still yet another aspect of the system, the system may include stored instructions that, when executed by the one or more processors, may further cause the system to receive, from the user device, API generation criteria indicating the one or more operational characteristics of the optimized API, wherein executing the generative AI model to generate the optimized API may be further based upon the user API generation criteria.

In another aspect of the system, the system may include stored instructions that, when executed by the one or more processors, may further cause the system to receive, from the user device, a request for code of the optimized API, and provide, to the user device, the code of the optimized API.

In yet aspect of the system, the user-specific API transaction data may include one or more of: API request data, API response data, an API transaction type, or an API method.

In another aspect, a computer-implemented method for dynamically generating optimized APIs. The computer-implemented method may include (i) obtaining, by one or more processors, an API call data stream of one or more API calls from a user device to a plurality of APIs of an API platform, and API data indicating one or more operational characteristics of one or more APIs of the plurality of APIs; (ii) analyzing, by the one or more processors, the API call data stream to generate user-specific API transaction data corresponding to the one or more API calls, the user-specific API transaction data may indicate information exchanged between the user device and the plurality of APIs during the one or more API calls; (iii) executing, by the one or more processors, a generative AI model trained using training data to generate an optimized API having at least a portion of the one or more operational characteristics of the one or more APIs, causing the generative AI model to: (a) receive the user-specific API transaction data and the API data; and (b) generate, based on the API transaction data and the API data, the optimized API; and (iv) updating, by the one or more processors, the API platform to implement the optimized API, wherein the API platform is configured to receive and respond to calls from one or more client devices. The computer-implemented method may include additional, less, or alternate functionality or actions, including that discussed elsewhere herein.

In another aspect, a non-transitory computer-readable medium storing processor-executable instructions for dynamically generating optimized application programming interfaces (APIs), the instructions that, when executed by one or more processors, cause the one or more processors to at least: (i) obtain an API call data stream of one or more API calls from a user device to a plurality of APIs of an API platform, and API data indicating one or more operational characteristics of one or more APIs of the plurality of APIs; (ii) analyze the API call data stream to generate user-specific API transaction data corresponding to the one or more API calls, the user-specific API transaction data indicating information exchanged between the user device and the plurality of APIs during the one or more API calls; (iii) execute a generative AI model trained using training data to generate an optimized API having at least a portion of the one or more operational characteristics of the one or more APIs, causing the generative AI model to: (a) receive the user-specific API transaction data and the API data; and (b) generate, based on the API transaction data and the API data, the optimized API; and (iv) update the API platform to implement the optimized API, wherein the API platform is configured to receive and respond to calls from one or more client devices. The instructions may direct additional, less, or alternate functionality, including that discussed elsewhere herein.

In accordance with the above, and with the disclosure herein, the present disclosure includes improvements in computer functionality and/or improvements to other technologies at least because the claims recite, e.g., a generative AI model (GAIM) configured to generate an optimized API. The optimized API can be generated based upon API transaction data, API data, and/or API generation criteria, and may include the functionality of one or more existing APIs. For example, the API transaction data may be based at least in-part on monitoring API call traffic. Once analyzed (e.g., by the GAIM), the forensic data of the API call traffic may indicate the transaction type/class based upon characteristics such as latency, response time, a requirement of the API to introduce a delay while waiting for a response, size of the request and/or response data (e.g., the total amount of megabytes and/or gigabytes of a given request and/or response), time of the day the transaction occurs, etc. For example, a RESTful API that interacts with a user screen, a machine to machine interface API, and a file transfer API may each have different interaction semantics indicating the type of API. These aspects of the API transaction data, or other suitable behavioral aspects of API transaction data associated with the API class, may be used to train and/or fine-tune the GAIM and/or LLM which may be included with the GAIM to further optimize generated APIs. For example, API transaction data may indicate, during training of the GAIM and/or LLM, that certain API calls are associated with an API class type that is classified as for looking up membership in an organization. Based upon monitoring and analyzing (e.g., via the LLM) several membership API calls, the GAIM may begin to associate certain functions and/or data with member API calls (e.g., retrieve member name, address, subscription, etc). Based upon this information, the GAIM may determine that certain membership API calls may already be more optimized than others (e.g., based upon the speed of the transaction associated with the call, the data returned by the call, etc.), such that when generating new optimized APIs that are also membership-type APIs, the GAIM may use the more optimized existing APIs of this class as a basis for the new API it generates. With respect to the existing membership-type APIs the GAIM determines are less optimized than others, it may further optimize them based upon the knowledge/training from monitoring the membership class of APIs. For example, based upon two API calls made after a non-optimized membership-type API call, the GAIM may generate a single optimized API which wraps and streamlines all three API calls into the single optimized API. In this sense, the by detecting the API class/type of API calls in API transaction data, the GAIM (including the LLM associated with the GAIM) may fine-tune it's generative capabilities with respect to specific types/classes of APIs.

In addition, the GAIM can be applied to API data of many multiples (e.g., hundreds or thousands) of different existing APIs, each with different formats, syntaxes, function parameters, function outputs, communication protocols, classes/types, and/or other code, function, or other API-based differences, and similarly generate many multiples of optimized APIs having such differences. That is, the GAIM can be implemented or executed to analyze various existing APIs and API call traffic associated therewith, to create the optimized API, which may optimize existing API functions or code and/or define new API functions or code, to generate a new, more efficient and/or streamlined optimized API when compared to the previous multiple APIs. In various aspects, the optimized API may comprise a reduced set of functions and/or code when compared to the original, different APIs and/or API data from which the new API was generated. For example, in one aspect, the optimized API may include a single function that replaces two or more functions in respective two or more APIs. Still further, the single function can also be formatted or refactored to accept fewer parameters and/or be accessed in a single programming language and/or protocol, which streamlines calls to the optimized API from other devices (e.g., other systems or a client device, such as a user device). In another aspect, for example, the optimized API may use generative AI to generate the optimized API which expands the functionality of one or more existing APIs, for example based upon API generative criteria provided by a user. In various aspects, an API platform may be updated to implement the optimized API in order to improve the functionality of the API platform itself. That is, the present disclosure describes improvements in the functioning of the computer itself or “any other technology or technical field” because the code base, as used by the optimized API, may be reduced, streamlined, enhanced, or otherwise optimized, which not only improves the underlying device by requiring less memory for storage of the optimized API (compared to the original multiple APIs from which it is generated), but also improves the execution speed and/or efficiency of the optimized API by the underlying device. This improves over the prior art at least because system or platforms, which would otherwise be required to implement multiple, different APIs, which would require increased memory storage and/or execution compute cycles by processing devices, may now implement the optimized API.

The present disclosure includes specific features other than what is well-understood, routine, conventional activity in the field, and/or otherwise adds unconventional steps that confine the disclosure to a particular useful application, e.g., systems and methods for dynamically generating optimized APIs for an API platform using AI, based upon API transaction data, API data, and/or user API generation criteria.

Additional, alternate and/or fewer actions, steps, features and/or functionality may be included in an aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer environment in which methods and systems for dynamically generating optimized APIs using AI are implemented, according to one embodiment.

FIG. 2 depicts a block diagram of an exemplary mobile device in which computer-implemented methods and systems for dynamically generating optimized APIs using AI are implemented, according to one embodiment.

FIG. 3 depicts a combined block and logic diagram for training a generative AI model to dynamically generate optimized APIs, according to one embodiment.

FIG. 4A depicts a workflow block diagram for generating an optimized API, according to one embodiment.

FIG. 4B depicts an example user interface of an API platform to request an optimized API, according to one embodiment.

FIG. 4C depicts an example wireframe for providing API generation criteria to an API platform, according to one embodiment;

FIG. 4D depicts a block diagram of an example optimized API, according to one embodiment.

FIG. 5 depicts a flow diagram of an exemplary computer-implemented method for dynamically generating optimized APIs using AI, according to one embodiment.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, dynamically generating optimized APIs. Using the disclosed techniques to dynamically generate one or more optimized APIs in an automated fashion based API data associated with existing APIs and API transaction data of API calls to the APIs, provides the user the ability to quickly and easily generate optimized APIs, which may include optimization based upon user-provided API generation criteria, which fulfill required API operational characteristics. This approach will reduce the time to develop and provide optimized API solutions for composing and integrating technology and services from multiple providers. This may include more efficient customized APIs without the added costs of manual creation of such APIs, faster development and testing of APIs based on use cases and known best practices, more responsive development and delivery of APIs as traffic profiles and user experiences evolve, and/or transparent monitoring of API traffic leading to streamlined API management and API function and size reduction, which eliminates or replaces legacy and unused APIs, among other things.

The disclosed systems and methods dynamically generate optimized APIs for an API platform using AI. As further described below, an API platform of a server may include an API database or other memory may store API data of a plurality of existing APIs of the API platform. The API data may indicate operational characteristics of the plurality of existing APIs, such as methods, functions, endpoints, actions, request parameters, data formats, use cases, security characteristics, responses, and/or other suitable operational characteristics of the plurality of APIs. The API data may be based upon documentation of an API, historical API mappings, metadata associated with the API, etc.

The API platform may include the GAIM which is trained to generate the optimized API (e.g., using the LLM and/or GraphQL) which may have at least a portion of the operational characteristics of one or more APIs. The GAIM is trained using training data which may include historical transaction data and historical API data.

The API platform may obtain an API call data stream of one or more API calls from a user device to the plurality of APIs, and further analyze the API call data stream to generate user-specific API transaction data corresponding to the one or more API calls. The user-specific API transaction data may indicate information exchanged between the user device and the plurality of APIs during the one or more API calls, and may include API request data, API response data, an API transaction type, and/or an API method.

The API platform may execute the GAIM to receive the user-specific API transaction data and the API data. The GAIM may generate, based upon the user-specific API transaction data and the API data, the optimized API. The optimized API may be based upon one or more APIs and include one or more new functions not provided by the one or more API, and/or one or more reconfigured functions of the one or more APIs.

In at least some aspects, the API platform may receive, from the user device, API generation criteria indicating the one or more operational characteristics of the optimized API. The GAIM may generate the optimized API further based upon the user API generation criteria.

In at least some aspects, the API platform may execute one or more tests of the optimized API using historical API traffic data, and configure the optimized API for execution based upon the optimized API achieving at least a metric during the one or more tests.

The API platform may update the API platform to implement the optimized API, wherein the API platform is configured to receive and respond to calls from one or more client devices. In at least some aspects, the API platform may receive, from the user device, a request for code of the optimized API and provide the code of the optimized API to the user device.

As used herein, the artificial intelligence/AI may refer to one or more technologies, such as but not limited to, machine learning (ML), (recurrent) neural networks, generative adversarial networks, and/or AI/ML models, that can perform tasks which typically require human intelligence, e.g., learning, reasoning, problem-solving, perception, language understanding, generating content, etc. Accordingly, “artificial intelligence” and/or “AI” may be used interchangeably with “machine learning,” “ML,” and/or terminology for similar technologies.

### Exemplary Computer Environment

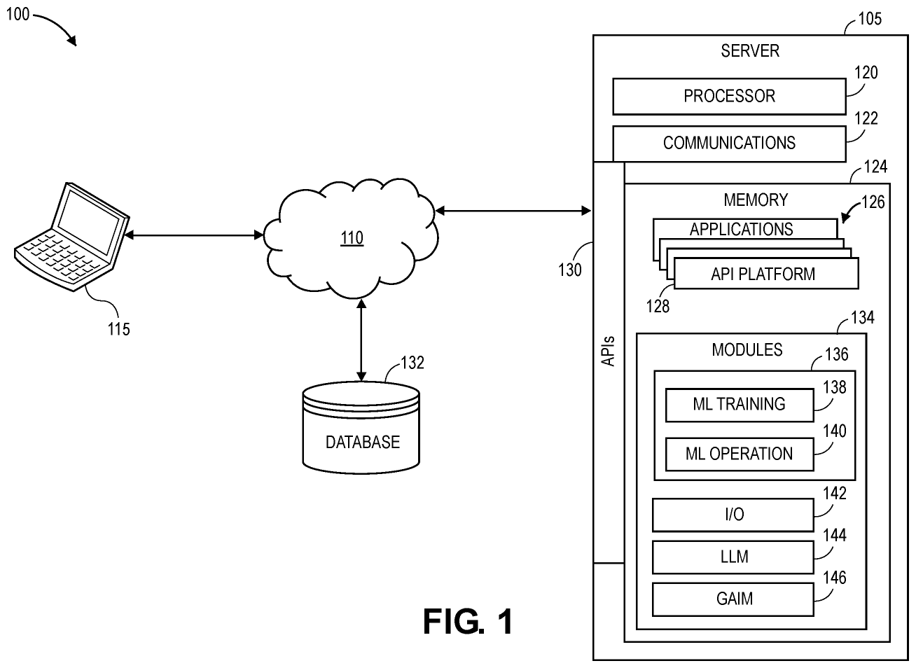

FIG. 1 depicts an exemplary environment 100 associated with dynamically generating optimized APIs for an API platform using AI. Although FIG. 1 depicts certain entities, components, equipment, and devices, it should be appreciated that additional or alternate entities, components, equipment, and devices are envisioned.

As illustrated in FIG. 1, the computing environment 100 may include, in one aspect, one or more servers 105 which may perform the at least some of the functionalities and techniques disclosed, such as dynamically generating optimized APIs for an API platform using AI. The servers 105 may be part of a cloud network or may otherwise communicate with other hardware or software components within one or more cloud computing environments to send, retrieve, or otherwise analyze data or information described herein. In one example, in certain aspects of the present techniques, the computing environment 100 may comprise an on-premise computing environment, a multi-cloud computing environment, a public cloud computing environment, a private cloud computing environment, and/or a hybrid cloud computing environment. In one example, an entity (e.g., a business providing APIs for its software applications) may host one or more services in a public cloud computing environment (e.g., Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by the business. The public cloud may be partitioned using visualization and multi-tenancy techniques and/or may include one or more of software-as-a-service (SaaS), infrastructure-as-a-service (IaaS) and/or platform-as-a-service (PaaS).

The computing environment 100 may include a network 110 comprising any suitable network or networks, including a local area network (LAN), wide area network (WAN), Internet, or combination thereof. For example, the network 110 may include a wireless cellular service (e.g., 4G service, 5G service, 6G service, etc.). Generally, the network 110 enables bidirectional communication between the servers 105 and a user device 115. In one aspect, the network 110 may comprise a cellular base station, such as cell tower(s), communicating to the one or more components of the computing environment 100 via wired/wireless communications based upon any one or more of various mobile phone standards, including NMT, GSM, CDMA, UMTS, LTE, 5G, 6G, or the like. Additionally or alternatively, the network 110 may comprise one or more routers, wireless switches, or other such wireless connection points communicating to the components of the computing environment 100 via wireless communications based upon any one or more of various wireless standards, including by non-limiting example, IEEE 802.11a/ac/ax/b/c/g/n (Wi-Fi), Bluetooth, and/or the like.

The servers 105 may include one or more processors 120. The processors 120 may include one or more central processing units (CPUs), graphics processing units (GPUs), and/or any other suitable processor. The processors 120 may be communicatively coupled to a memory 124 via a computer bus (not depicted) to create, read, update, transmit, delete, or otherwise access or interact with the data, data packets, or otherwise electronic signals to and from the processors 120 and memory 124, e.g., in order to implement or perform the machine-readable instructions, methods, processes, elements, or limitations, as illustrated, depicted, or described for the various flowcharts, illustrations, diagrams, figures, and/or other disclosure herein. The processors 120 may interface with the memory 124 via a computer bus to execute an operating system (OS) and/or computing instructions contained therein, and/or to access other services/aspects. For example, the processors 120 may interface with the memory 124 via the computer bus to create, read, update, delete, or otherwise access or interact with the data stored in the memory 124 and/or one or more databases 132.

The servers 105 may include a communications component 122 which allows the servers 105 to communicate over the network 110 (e.g., with user device 115, databases 132) via any suitable wired and/or wireless connection, e.g., using any suitable network interface controller(s) of the communications component 122. The communications component 122 may include one or more transceivers (e.g., WWAN, WLAN, and/or WPAN transceivers) functioning in accordance with IEEE reference standards, 3GPP reference standards, and/or other reference standards that may be used in receipt and transmission of data via external/network ports of the servers 105 connected to computer network 110.

The memory 124 may include one or more memories and/or forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 124 may store machine-readable instructions executable by the processors 120, including any of one or more application(s) 126, one or more software component(s), and/or one or more APIs 130.

The one or more applications 126 may include an operating system (OS) (e.g., Microsoft Windows, Linux, UNIX, etc.) capable of facilitating the functionalities, applications, methods, or other software as discussed herein. In general, a computer program or computer based product, application, instructions, or code (e.g., machine learning models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 124) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The software applications 126 may include an API platform 128. The API platform 128 may provide various functionalities, alone or in combination with other components of the computing environment 100 as further described herein, to dynamically generate optimized APIs which are offered and/or supported by the API platform 128, e.g., for execution by a user of the API platform 128.

In at least some aspects, the API platform 128 may provide and/or support the one or more existing APIs 130. For example, the API platform 128 may receive an API call from a software application of the user device 115 via network 110 and communications component 122, and route the API call to the associated one or more APIs 130. The API platform 128 may generate API data indicating operational characteristics of the one or more APIs 130, which may include storing and/or retrieving the API data in one or more memories, such as memory 124 and/or databases 132.

In at least some aspects, the API platform 128 may capture, obtain, and/or analyze the API call data stream of one or more API calls from the user device 115 to the one or more APIs 130, e.g., via network 110. The API platform 128 may generate API transaction data corresponding to the one or more API calls, which may include user-specific API transaction data. The API transaction data may indicate information exchanged between the user device 115 and the one or more APIs 130 during the API calls. The API platform 128 may store to and/or retrieve from, one or more memories the API call data stream and/or (user-specific) API transaction data, such as memory 124 and/or databases 132. For example, the API platform may monitor and analyze multiple API calls between a software application of a user device 115 and two APIs 130 via the API call data stream, extract the user-specific API transaction data, and provide the user-specific API transaction data and API data associated with the two API 130 as inputs to the LLM 144 and/or GAIM 146.

In at least some aspects, the API platform 128 may operate in conjunction with an ML module 134, an ML training module 138, an ML operation module 140, the LLM 144, the GAIM 146 and/or other suitable component of the computing environment 100 to dynamically generate the optimized APIs. For example, once the API platform 128 provides the user-specific API transaction data and API data as inputs to the GAIM 146 as referred to above, the GAIM 146 may generate the optimized API. The API platform 128 may then provide the optimized API for execution by a user via the API platform 128, e.g., by configuring and/or testing a beta version of the optimized API, storing the optimized API as the one or more APIs 130 provided by the API platform 128, storing the API data associated with the optimized API to memory, etc. In at least some aspects, the API platform 128 may store the (user-specific) API transaction data, the API data, and/or any other suitable data as training data in one or more memories (e.g., memory 124, databases 132), which may be used to train one or more ML models, such as LLM 144 and/or GAIM 146.

In at least some aspects, the server 105 and/or API platform 128 may provide a user access to the API platform 128, e.g., via one or more user interface devices (e.g., keyboard, mouse, display) connected to the server 105 via an input/output (I/O) module 142, via a website and/or portal associated with the API platform 128 and available via the network 110 (e.g., using a browser of the user device 115), via an API platform client application executed on the user device 115, and/or in any other suitable manner. For example, a user device 115 executing the API platform client application may access the API platform 128 via the network 110 to provide API generation criteria, download code associated with the optimized API, etc.

The one or more APIs 130 may allow two or more software applications, software components, software services, etc., to use API calls to communicate and/or interact with one another (e.g., via the communication component 122 and/or the network 110), exchange data, or other suitable functions carried out by the APIs 130. For example, the server 105 may provide one or more APIs 130 for one or more of the software applications 126, allowing software applications executing on another device, such as the user device 115 communicatively coupled to the server 105, to interact and/or share data with the software applications 126 associate with the APIs 130. Once the API platform 128 (e.g., via the GAIM 146) generates the optimized API, it may be stored as the one or more APIs 130.

The server 105 may include, and/or have access to (e.g., via network 110) one or more databases 132. The databases 132 may be or include a relational database, such as Oracle, DB2, MySQL, a NoSQL based database, such as MongoDB, or another suitable database. The databases 132 may store data and/or datasets, such as API code, training datasets used to train and/or operate one or more ML models, among other things. A dataset may include one or more types of data, records, files, etc., however, the term data and dataset may be used interchangeably herein.

The databases 132 may include API data of a plurality of APIs, such as the APIs 130. The API data may indicate operational characteristics of the plurality of APIs 130, such as of methods, functions, endpoints, actions, request parameters, data formats, use cases, security characteristics, responses, and/or other suitable operational characteristics of the APIs 130. The API data may be based upon documentation of the associated API 130, metadata associated with the API 130, data generated from API calls to the API 130 (e.g., API calls between applications of the user device 115 and server 105), and/or any other suitable source of API data.

The memory 124 may store a plurality of computing modules 134, implemented as respective sets of computer-executable instructions (e.g., one or more source code libraries, trained AI/ML models such as neural networks, convolutional neural networks, etc.) as described herein.

In one aspect, the computing modules 134 may include an ML module 136. The ML module 136 may include ML training module (MLTM) 138 and/or ML operation module (MLOM) 140. In some embodiments, at least one of a plurality of ML methods and algorithms may be applied by the ML module 136, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning.

In one aspect, the ML based algorithms may be included as a library or package executed on server(s) 105. For example, libraries may include the TensorFlow based library, the PyTorch library, and/or the scikit-learn Python library.

In one embodiment, the ML module 136 employs supervised learning, which involves identifying patterns in existing data to make predictions about subsequently received data. Specifically, the ML module is “trained” (e.g., via MLTM 138) using training data, which includes exemplary inputs and associated exemplary outputs. Based upon the training data, the ML module 136 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 136 may employ unsupervised learning, which involves finding meaningful relationships in unorganized data. Unlike supervised learning, unsupervised learning does not involve user-initiated training based upon exemplary inputs with associated outputs. Rather, in unsupervised learning, the ML module 136 may organize unlabeled data according to a relationship determined by at least one ML method/algorithm employed by the ML module 136. Unorganized data may include any combination of data inputs and/or ML outputs as described above.

In yet another embodiment, the ML module 136 may employ reinforcement learning, which involves optimizing outputs based upon feedback from a reward signal. Specifically, the ML module 136 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 138 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 140 may comprising a set of computer-executable instructions implementing ML loading, configuration, initialization and/or operation functionality. The MLOM 140 may include instructions for storing trained models (e.g., in the electronic databases 132). As discussed, once trained, the one or more trained ML models may be operated in inference mode, whereupon when provided with de novo input that the model has not previously been provided, the model may output one or more predictions, classifications, etc., as described herein.

In operation, ML model training module 138 may access databases 132 or any other data source for training data suitable to generate one or more ML models. The training data may be sample data with assigned relevant and comprehensive labels (classes or tags) used to fit the parameters (weights) of an ML model with the goal of training it by example. In one aspect, once an appropriate ML model is trained and validated to provide accurate predictions and/or responses, the trained model may be loaded into MLOM 140 at runtime to process input data and generate output data.

While various embodiments, examples, and/or aspects disclosed herein may include training and generating one or more ML models for the server 105 to load at runtime. Additionally, or alternatively, one or more appropriately trained ML models may already exist (e.g., in databases 132) such that the server 105 may load an existing trained ML model at runtime. In some implementations, server 105 may retrain, fine-tune, update and/or otherwise alter an existing ML model before and/or after loading the model at runtime.

In one aspect, the computing modules 134 may include the I/O module 142, comprising a set of computer-executable instructions implementing communication functions. The I/O module 142 may include a communication component configured to communicate (e.g., send and receive) data via one or more external/network port(s) to one or more networks or local terminals, such as the computer network 110 and/or the user device 115 described herein. In one aspect, the server 105 may include a client-server platform technology such as ASP.NET, Java J2EE, Ruby on Rails, Node.js, a web service or online API, responsive for receiving and responding to electronic requests.

I/O module 142 may further include or implement an operator interface configured to present information to an administrator or operator and/or receive inputs from the administrator and/or operator. An operator interface may provide a display screen. The I/O module 142 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 115. According to one aspect, an administrator or operator may access the servers 105 via the user device 115 to review information, make changes, input training data, initiate training via the MLTM 138, and/or perform other functions (e.g., operation of one or more trained models via the MLOM 140). In some aspects, the I/O module 142 may facilitate communications between the APIs 130 of the server 105 and other devices, such as user device 115.

The computing modules 130 may include one or more LLMs 144. The LLM 144 may be designed and/or trained to understand and generate human-like language and/or text. The LLM 144 may perform various natural language processing tasks and generate coherent and contextually relevant text. In at least some aspects, the LLM 144 may be trained using historical API data, historical (user-specific) API transaction, historical API generation criteria, and/or other suitable training data interpret the context of such data via associated text, and similarly generate textual data associated with APIs, such as API code. In at least some aspects, the LLM 144 may operate in conjunction with, and/or be part of, the GAIM 146, e.g., to generate the optimized API. For example, the LLM 144 may be trained to receive API data and/or (user-specific) API transaction data from the API platform 128 to understand the operational characteristics of the associated API and/or API calls, such as the functions, request/response data, etc. More specifically, a function of the optimized API may include providing response data to a user which includes information about their investments. The LLM 144 may analyze the response data during testing of the optimized API to determine whether it includes investment information, whether the investment information is associated with the correct user, etc.

The computing modules 130 may include one or more GAIMs 146. Generally speaking, the GAIM 146 may be trained (e.g., via MLOM 134) to receive input data (e.g., via the API platform 128) and generate as an output new content which is similar to the input and/or training data it was trained on. The GAIM 146 may include a Generative Adversarial Network (GAN), generative language model such as GPT (Generative Pre-trained Transformer), or any other suitable generative model. In at least some aspects, the GAIM 146 may be trained using historical API data, historical (user-specific) API transaction data, historical API generation criteria, or any other suitable training data, to generate new and/or optimized APIs when receiving (e.g., from the API platform 128) API data, (user-specific) API transaction data, API generation criteria, or other suitable data as input(s). For example, the GAIM 146 may receive user-specific API transaction data and API data indicating three API calls to three APIs 130, determine a single optimized API may provide the functionality of the three APIs 130, and generate the single optimized API.

The one or more servers 105 may also be in communication with one or more user devices 115, e.g., a user device associated with a user requesting information/data from, and or providing information/data to, one or more applications of the server 105 such as API platform 128. The user device 115 may comprise one or more computers and/or multiple, redundant, or replicated client computers accessed by one or more users. The user device 115 may access services or other components of the computing environment 100 via the network 110. The user device 115 may include one or more computing devices (e.g., desktop computer, laptop computer, terminal), mobile devices, wearables, smart watches, smart contact lenses, smart glasses, AR glasses/headsets, VR glasses/headsets, mixed or extended reality glasses/headsets, voice bots or chatbots, ChatGPT bots, and/or other suitable electronic or electrical components. The user device 115 may include a memory and a processor for, respectively, storing and executing one or more modules, computer-executable instructions, etc. The memory may include one or more suitable storage media such as a magnetic storage device, a solid-state drive, random access memory (RAM), etc. The user device 115 may access services or other components of the computing environment 100 via the network 110, as further described below.

In some embodiments, the computing environment 100, e.g., via the API platform 128, may dynamically generate optimized APIs. The API platform 128 may obtain the API call data stream of one or more API calls, such as by monitoring the API call data stream via the network 110, of software applications and/or devices making API calls to the one or more APIs 130 of the API platform 128. The API platform 128 may analyze the API call data stream to generate API transaction data corresponding to the one or more API calls, such as API request data, API response data, the API transaction type, the API method, etc. In at least some aspects, the API transaction data may be user-specific, e.g., the API transaction data may indicate the information exchanged between the software application(s) of user device 115 and the APIs 130 during one or more API calls, and/or be otherwise associated with a specific user of the API platform 128 (e.g., based upon user credentials associated with one or more API calls, user device identifying information, etc.). In some aspects, the API platform 128 may store on, and/or retrieve from, the one or memories such as memory 124 and/or databases 132, the API call data steam and/or the API transaction data. For example, the API platform 128 may store in database 132 the data associated with an API data stream of API calls to the APIs 130, and retrieve the data of the API data stream at a later date for analysis and/or extraction of the associated API transaction data.

The API platform 128 may execute the GAIM 146 to generate the optimized API based upon the (user-specific) API transaction data and the API data associated with the APIs 130 provided by the API platform 128. In at least some aspects, the GAIM 146 may be trained using training data (e.g., training data stored in database 132) to learn associations and/or relationships in the training data which may indicate an optimized API, such that when the API platform 128 provides input data (e.g., API data, (user-specific) API transaction data, API generation criteria) to the GAIM 146, the GAIM 146 may generate the optimized API, which may include at least a portion of the operational characteristics of the one or more of the APIs 130.

For example, the user-specific API transaction data generated from a plurality of call data streams between the user device 115 and the APIs 130 may indicate that user device 115 repeatedly makes four separate API calls to four different APIs 130 providing access to services via the API platform 128, and further that the four API calls are always executed in the same order. Based upon this information, the GAIM 146 may determine that a single, optimized API may be generated which makes a single API call to the API platform 128 for the associated services in the same order as indicated by the user-specific API transaction data.

The GAIM 146 may then, based upon the API transaction data and the API data, generate the optimized API, e.g., by generating the code associated with the optimized API, which may include a beta optimized API. In at least some aspects, generating the optimized API may include the LLM 144 as previously described, and/or GraphQL (e.g., the GraphQL query language and/or runtime engine). For example, GraphQL may allow the GAIM 146 to generate the optimized API with operational characteristics which allow the optimized API to provide only specific data required by the user, whereas other technologies, such as Representational State Transfer (REST) based APIs, may only allow the API to provide a fixed set of data, such that over-fetching or under-fetching of data may occur with non-GraphQL based APIs.

In at least some aspects, the user may be able to provide the API generation criteria indicating one or more operational characteristics the optimized API should and/or must have. The API generation criteria may include a method, a function, an endpoint, an action, a request parameter, a data format, a use case, a security characteristic, a response, and/or other suitable API generation criteria. The GAIM 146 may use the API generation criteria as an input when generating the optimized API so that the optimized API satisfies the API generation criteria. For example, the user may execute the API platform client application to provide API generation criteria to the API platform 128, e.g., via answering questions associated with the API generation criteria, filling out a form associated with the API generation criteria, uploading a wireframe indicating the API generation criteria, and/or in any other suitable manner. For example, the API generation criteria may indicate a security characteristic of the optimized API. The GAIM 146 may not otherwise include the security characteristic when generating the optimized API based upon the API transaction data and the API data alone, and when using the API generation criteria as an input to the GAIM 146, the optimized API will include the security characteristic.

In at least some aspects, the LLM 144 may execute, and/or be included when performing, one or more operations, functions, steps, etc., of the server 105, API platform 128 and/or the GAIM 146. For example, the GAIM 146 may include the LLM 144 to analyze the user-specific API transaction data and API data to generate code for the optimized API, to analyze results of test associated with the API (e.g., the content of data received as a response), or any other suitable use.

The API platform 128 may further test and/or configure the optimized API for execution. For example, the API platform 128 via the GAIM 146 may generate a beta optimized API which may be tested and/or configured by the GAIM 146, LLM, 144, API platform 128, and/or other suitable component. In at least some aspects, testing the (beta) optimized API may include executing one or more tests on the optimized API, e.g., testing the optimized API for performance or other requirements in a sandbox testing environment. The one or more tests may include using historical API traffic data, for example to determine whether the (beta) optimized API generates and/or provides data as expected based upon the data generated/provided in the historical API traffic data. In at least some aspects, one or more tests of the optimized API may be associated with a metric, such as a score, rating, etc. Once a certain metric is achieved by the optimized API during one or more tests, the optimized API may be considered to be adequately tested, optimized, etc.

In at least some aspects, the (beta) optimized API undergoes configuring, e.g., by the API platform 128. For example, the GAIM 146 may generate a beta optimized API based at least in part on receiving user-specific API transaction data as an input. The API platform 128 may configure the beta optimized API with security credentials (e.g., user authentication) specific to the user associated with the user-specific API transaction, although the (beta) optimized API platform 128 may configured in any other suitable manner.

The API platform 128 may update the API platform 128 to implement the optimized API, such that the API platform 128 is configured to receive and respond to calls from one or more client devices. The API platform 128 may provide the optimized API for execution by a user via the API platform 128, e.g., as the API 130 available for execution by the one or more suitable users of the API platform 128. The API platform 128 may store in an API database, such as database 132, the data associated with the optimized API, such as API data which indicates its operational characteristics. The API platform 128 and/or GAIM 146 may subsequently use the data of the optimized API for one or more suitable purposes, e.g., as inputs when generating subsequent optimized APIs, as training data for updating/retraining the GAIM 146 or other model, etc.

In at least some aspects, the API platform 128 may allow a user to download the optimized API, e.g., when downloading the code of the optimized API. For example, the user of the user device 115 may execute the API platform client application, allowing the user to select an icon of a GUI to download the optimized API. Once the user selects the download icon, a request may be sent to the API platform 128 by the user device 115 (e.g., via network 110) to provide the code of the optimized API to the user device 115. In at least some aspects, downloading the API code may be part of the optimized API configuration and/or testing.

Although the computing environment 100 is shown to include one user device 115, one server 105, and one network 110, it should be understood that different numbers of user devices 115, networks 110, and/or servers 105 may be utilized. In one example, the computing environment 100 may include a plurality of servers 105 and/or hundreds or thousands of user devices 115, all of which may be interconnected via the network 110.

The computing environment 100 may include additional, fewer, and/or alternate components, and may be configured to perform additional, fewer, or alternate actions, including components/actions described herein. Although the computing environment 100 is shown in FIG. 1 as including one instance of various components such as server 105, network 110, user device 115, etc., various aspects include the computing environment 100 implementing any suitable number of any of the components shown in FIG. 1 and/or omitting any suitable ones of the components shown in FIG. 1. For instance, information described as being stored at databases 132 may be stored at memory 124, and therefore databases 132 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and database 132 may be connected via a direct communication link (not shown in FIG. 1) instead of, or in addition to, via network 110.

### Exemplary User Device

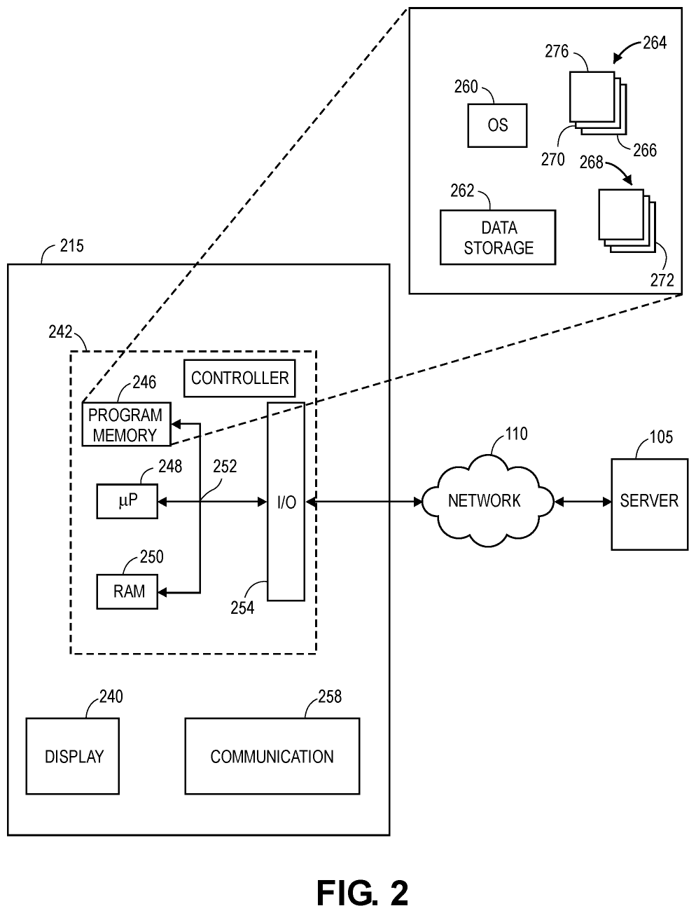

FIG. 2 depicts an exemplary user device 215, such as the user device 115. The user device 215 may include a display 240, a communication component 258, a user-input device (not shown), and a controller 242. The controller 242 may include a program memory 246, a microcontroller/processor/microprocessor (uP) 248 such as the processor 120, a random-access memory (RAM) 250, and/or an input/output (I/O) circuit 254, all of which may be interconnected via an address/data bus 252. The program memory 246 may include an operating system 260, a data storage 262, a plurality of software applications 264, and/or a plurality of software routines 268. The operating system 260, for example, may include one of a plurality of mobile platforms such as the iOS®, or Android™, developed by Apple Inc. and Google Inc., respectively.

The data storage 262 may include data such as application data for the plurality of applications 264, routine data for the plurality of routines 268, and/or other data necessary to interact with the one or more servers 105 through the network 110. In some embodiments, the controller 242 may also include, or otherwise be communicatively connected to, other data storage mechanisms (e.g., one or more hard disk drives, optical storage drives, solid state storage devices, etc.) that reside within the user device 215.

The communication component 258 may communicate with the one or more components or devices, such as server 105, via any suitable wireless communication protocol network, such as a wireless telephony network (e.g., GSM, CDMA, LTE, 5G, 6G, ultrawideband, etc.), a Wi-Fi network (e.g., having 802.11 standards), a WiMAX network, a Bluetooth network, etc. The user-input device (not shown) may include a “soft” keyboard that is displayed on the display 240 of the user device 215, an external hardware keyboard communicating via a wired and/or a wireless connection (e.g., a Bluetooth keyboard), an external mouse, a touchscreen, a stylus, and/or any other suitable user-input device.

The one or more processors 248 may be adapted and/or configured to execute any one or more of the plurality of software applications 264 and/or any one or more of the plurality of software routines 268 residing in the program memory 246, in addition to other software applications.

One of the plurality of applications 264 may be a native application and/or web browser 270, such as Apple's Safari®, Google Chrome™ mobile web browser, Microsoft Internet Explorer® for Mobile, Opera Mobile™, that may be implemented as a series of machine-readable instructions for receiving, interpreting, and/or displaying application screens or web page information from the one or more servers 105 while also receiving inputs from the user. Another application of the plurality of applications may include an embedded web browser 276 that may be implemented as a series of machine-readable instructions for receiving, interpreting, and/or displaying web page information.

One of the plurality of applications 264 may be an API platform client application 266 for performing the various tasks and/or functions associated with the API platform 128 and/or server 105, such as displaying a user interface (UI) to provide API generation criteria to the GAIM 146 via the API platform 128, receiving code for the optimized API, displaying information on, and/or transmitting information from, the user device 215 to the API platform 128 and/or server 105, etc. Additionally, the user may also launch or instantiate any other suitable user interface application (e.g., the native application or web browser 270, and/or any other one of the plurality of software applications 264) to access the one or more servers 105 and/or API platform 128 to realize aspects of the inventive system.

The user device 215 may include additional, fewer, and/or alternate components, and may be configured to perform additional, fewer, or alternate actions, including components/actions described herein. Although the user device 215 is shown in FIG. 2 as including one instance of various components such as display 240, processor 248, etc., various aspects include the user device 215 implementing any suitable number of any of the components shown in FIG. 2 and/or omitting any suitable ones of the components shown in FIG. 2. Moreover, various aspects include the user device 215 including any suitable additional component(s) not shown in FIG. 2, such as but not limited to the exemplary components described above. Furthermore, it should be appreciated that additional and/or alternative connections between components shown in FIG. 2 may be implemented.

### AI/ML Model Training

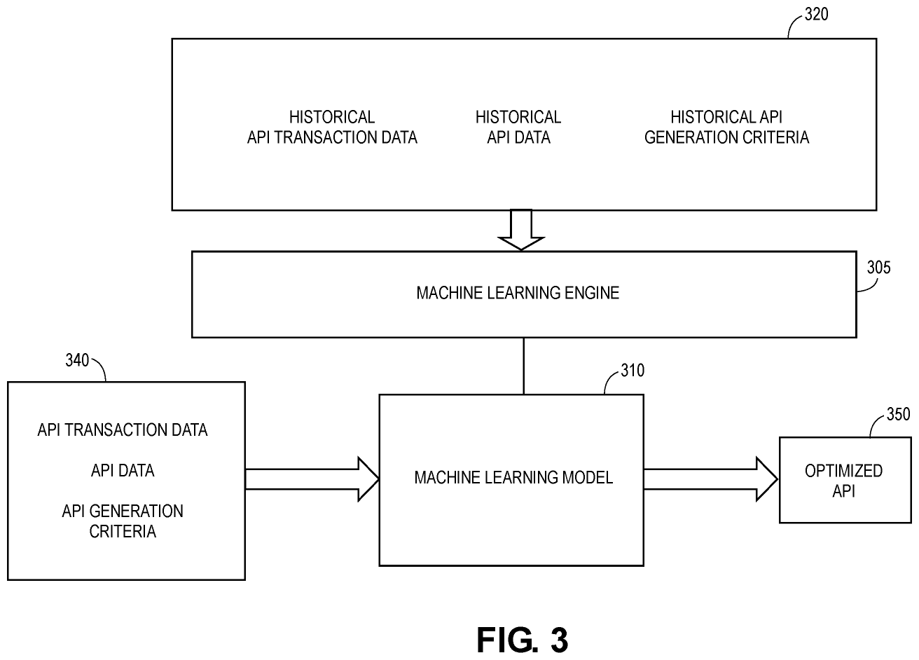

FIG. 3 schematically illustrates how an AI/ML model 310, such as the GAIM 146, may be trained to dynamically generate optimized APIs. Some of the blocks in FIG. 3 may represent and/or include hardware and/or software components, data structures or memory storing these data structures, registers, or state variables, and/or input and/or output data. Input signals may be represented by arrows labeled with corresponding signal names.

The ML engine 305 may include one or more hardware and/or software components (e.g., the ML module 136, the MLTM 138 and/or the MLOM 140) to obtain, create, (re) train, operate, fine-tune, and/or store one or more ML models, such as the ML model 310. To train the ML model 310, the ML engine 305 may use a training dataset 320. A server such as server 105 may obtain and/or have available one or more types of training data comprising a training dataset 320 (e.g., training data stored in databases 132). In one aspect, at least some of the training data 320 may be labeled to aid in (re) training and/or fine-tuning the ML model 310.

In at least some aspects, to train the ML model 310 to generate the optimized API, the training dataset 320 may include historical API data associated with a plurality of historical APIs, such as historical APIs of the API platform. The historical API data may indicate methods, functions, endpoints, actions, request parameters, data formats, use cases, security characteristics, responses, and/or other operational characteristics of the historical APIs.

The training dataset 320 may include historical API transaction data of historical data streams of historical API calls to the historical APIs, which may include historical user-specific API transaction data. The historical API transaction data may include API request data, API response data, an API transaction type, an API method, or any other suitable data associated with the historical API transaction. The API transaction data may include data indicating the transactions, events, and/or records of API calls generated when listening to, monitoring and/or analyzing API call traffic to existing APIs, or any other suitable data associated with the API calls/traffic. For example, and as previously described, the API transaction data of API traffic/calls may include information which can be associated by the ML model 310 during training with the transaction type and/or class of the API. Determining the class/type of the API may be based upon the behavioral characteristics of the API call/traffic, such as latency, response time, time of the day of the API call, etc. The behavioral characteristics may include patterns which indicate the transaction type/class, which may be used to (re) train and/or fine tune the ML model 310 (e.g., the GAIM and/or LLM) to associate specific API operational characteristics with specific types/classes of API, and further provide the ability to generate optimized APIs for specific API types/classes based upon such training. For example, the ML model 310 may be fine-tuned to generate classes/types of optimized APIs associated with the weather (e.g., those that provide weather data, forecasts, maps, etc.) based upon training using historical weather API call traffic. When the trained fine-tuned ML model 310 analyzes traffic of subsequent weather APIs, or receives API generation criteria associated with a weather API, it's training allows the ML model 310 to determine if the subsequent weather APIs may be optimized in some manner (e.g. recoded using GraphQL to return less data), and/or generate API code associated with a new optimized weather API based upon the API generation criteria, respectively.

The training dataset 320 may include historical API generation criteria. The historical API generation criteria may indicate functions, use cases, security characteristics, user experiences, or other suitable API characteristics of an historical user. The training dataset 320 may include any other suitable data for training the ML model 310 to generating the optimized API, among other things.

The ML model 310 may be configured to process the training dataset 320 to learn associations and relationships in the training data 320, e.g., relationships between historical API generation criteria and the historical API data of historical APIs which satisfy at least the portion of the historical API generation criteria.

In one aspect, the server, API platform, ML engine 305, or other suitable component may continuously update the training dataset 320, e.g., to include new data associated with the optimized API. For example, various types of training data 320 may be generated when the trained ML model 310 generates the optimized API, when the optimized API is configured, and/or when the optimized API is provided for execution by a user via the API platform, various types of data may be associated with the optimized API which the ML engine 305 may store as updated training data 320. This may include the API transactional data, API data and/or API generation criteria the ML model 310 uses as an input to generate the optimized API, the API data of the optimized API, etc. Subsequently, the ML model 310 may be retrained based upon the updated training dataset 320, which may further cause the ML model 310 to improve over time. For example, the API platform may generate an optimized weather API based upon two existing APIs, but having a new functions. The API platform may test the optimized weather API using historical API traffic of the two existing APIs to understand how the optimized weather API performs during testing. The data output by the optimized weather API during testing and the API data associated with the optimized weather API once fully tested/configured may be example of data which may be saved as updated training data.

In one aspect, the ML engine 305 may process and/or analyze the training dataset 320 (e.g., via MLTM 138) to train the ML model 310 to generate the optimize API. The ML model 310 may be trained via regression, k-nearest neighbor, support vector regression, and/or random forest algorithms and/or models, although any type of applicable ML algorithm and/or model may be used, including training using one or more of supervised learning, unsupervised learning, semi-supervised learning, and/or reinforcement learning.

Once trained, the ML model 310 may perform operations on one or more data inputs 340 to produce a desired data output 350. In one aspect, the ML model 310 may be loaded at runtime from a database (e.g., by ML engine 305 from the databases 132) to process the input data 340. The server, API platform, and/or ML engine 305 may obtain the input data 340 (e.g., from the databases 132), and provide the input data 340 to the trained ML model 310 as an input for the ML model 310 to generate the optimized API as an output 350. For example, to generate the optimized API as an output 350, the input data 340 may include API transaction data (e.g., user-specific API transaction data), API data, and/or API generation criteria, as previously described. The trained ML model 310 may make associations between the API transaction data, API data, and/or API generation criteria, to generate the optimized API as the output 350.

For example, the training data 320 may include historical API data of historical weather APIs. The historical API data may indicate operational characteristics of the historical weather APIs, such as historical request parameters including a location, a past date, a number of days of a forecast, etc., and may further indicate historical responses including a first historical API providing historical weather data associated with the location and date, and a second historical API providing a weather forecast for a span of time associated with the location. The training data 320 may further include historical API transaction data indicating one or more historical API calls of an historical user device to boteh the first and second historical APIs. The GAIM 310 may be trained by the ML engine 305 to learn associations between the historical API data and historical API generation criteria regarding which historical weather APIs satisfied which historical API generation criteria, whether calls to the historical weather APIs were made by the same device and/or in a specific order, etc. The trained GAIM 310 may then be able to receive as inputs 340 user-specific API transaction data and API data indicating API calls to two different APIs which provide both historical weather information and a weather forecast for the same location based upon the user providing a location and a past date as inputs. Based upon the inputs 340, the GAIM 310 may generate the optimized API which combines the functionality of the two existing weather APIs as an output 350.

### Generative AI

The GAIM such as GAIM 146 may be and/or include generative functionality allowing the GAIM to generate new content, such as images, text, or other forms of data, that is similar to, or inspired by, existing examples. These models operate on principles derived from machine learning, as previously described.

One prominent type of generative AI is Generative Adversarial Networks (GANs). GANs consist of two neural networks—the generator and the discriminator—that are trained in tandem through adversarial training. The generator aims to create data that is indistinguishable from real examples, while the discriminator's role is to differentiate between genuine and generated data. As these two networks iteratively compete and improve, the generator becomes adept at producing increasingly realistic content.

Another approach to generative AI involves Recurrent Neural Networks (RNNs) or transformers, which are used for sequential data generation, such as natural language text. These models learn patterns and dependencies in the training data and can then generate new sequences by predicting the next element based on the context provided.

In at least some aspects, the GAIM may be trained to generate code associated with an optimized API, which may further include GraphQL as previously described. For example, when trained with historical API code indicating functions which returns membership data for members of a charitable organization when receiving a request for such data, the GAIM may be able to generate similar code for an API which returns membership data for members of a fitness facility when receiving a request for such data.

### LLM

The present techniques may include language modeling via one or more LLMs, such as LLM 144, wherein one or more deep learning models are trained by processing token sequences using an LLM architecture. For example, in some aspects, a transformer architecture may be used to process a sequence of tokens. Such a transformer model may include a plurality of layers including self-attention and feedforward neural networks. This architecture may enable the model to learn contextual relationships between the tokens, and to predict the next token in a sequence, based upon the preceding tokens. During training, the model is provided with the sequence of tokens and it learns to predict a probability distribution over the next token in the sequence. This training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

In some aspects, the ML engine 305 and/or ML module 134, may include instructions for performing pretraining of a language model. The ML engine 305, for example, may include one or more sets of instructions for performing pretraining, which as used herein, generally refers to a process that may span pre-processing of training data and initialization of an as-yet untrained language model. In general, a pre-trained model is one that has no prior training of specific tasks. For example, the model pretraining module may include instructions that initialize one more model weights. In some aspects, model pretraining module may initialize the weights to have random values. The pretraining may train one or more models using unsupervised learning, wherein the one or more models process one or more tokens (e.g., preprocessed data) to learn to predict one or more elements (e.g., tokens). The pretraining may include one or more optimizing objective functions that the model pretraining module applies to the one or more models, to cause the one or more models to predict one or more most-likely next tokens, based on the likelihood of tokens in the training data. In general, the model pretraining causes the one or more models to learn linguistic features such as grammar and syntax. The pretraining may include additional steps, including training, data batching, hyperparameter tuning and/or model checkpointing.

The model pretraining may include instructions for generating a model that is pretrained for a general purpose, such as general text processing/understanding. This model may be known as a “base model” in some aspects. The base model may be further trained by downstream training process(es), for example via the ML engine 305. The model pretraining generally trains foundational models that have general understanding of language and/or knowledge. Pretraining may be a distinct stage of model training in which training data of a general and diverse nature (i.e., not specific to any particular task or subset of knowledge) is used to train the one or more models. In some aspects, a single model may be trained and copied. Copies of this model may serve as respective base models for a plurality of fine-tuned models.

In some aspects, base models may be trained to have specific levels of knowledge. For example, the model pretraining may train a base computer programming language model that may be subsequently used to fine tune an API language model. In this way, the base model can start from a relatively advanced stage, without requiring pretraining of each more advanced model individually. This strategy represents an advantageous improvement, because pretraining can take a long time (many days), and pretraining the common base model only requires that pretraining process to be performed once.

### API Platform

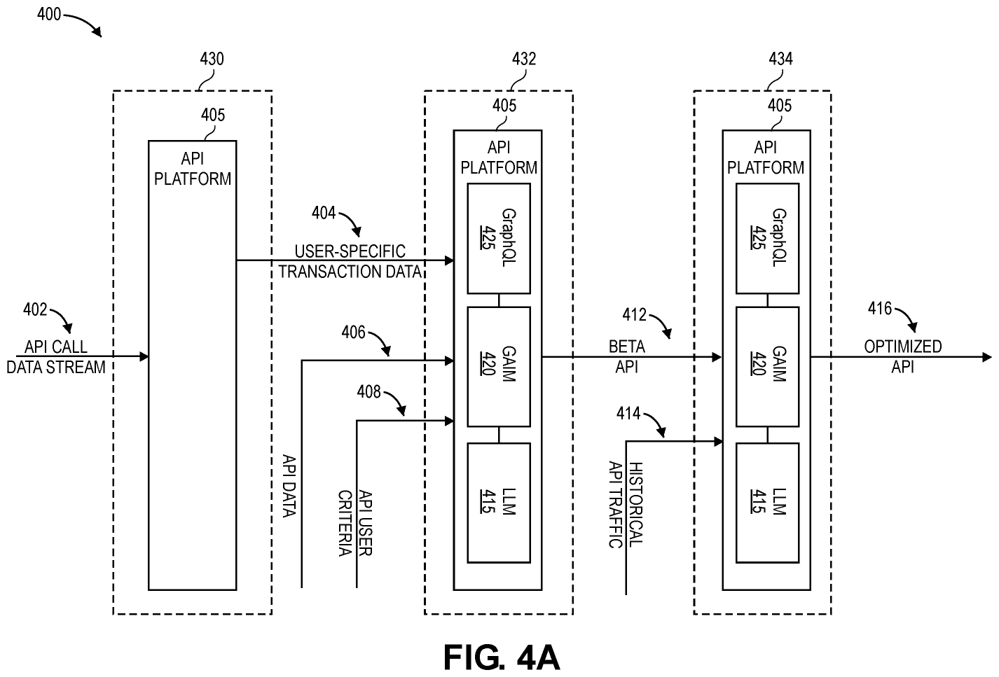

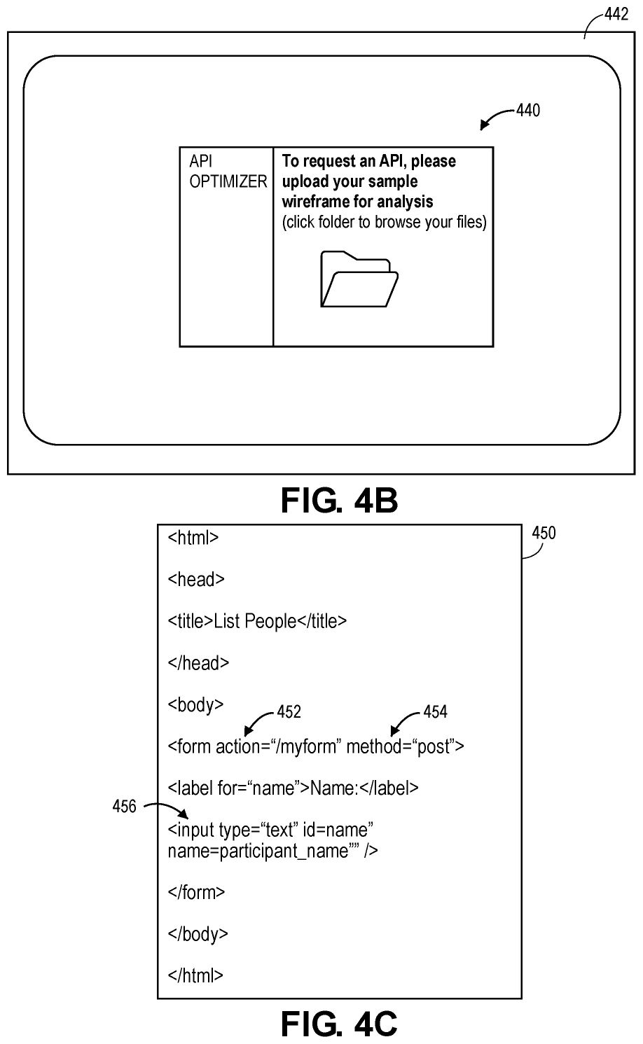

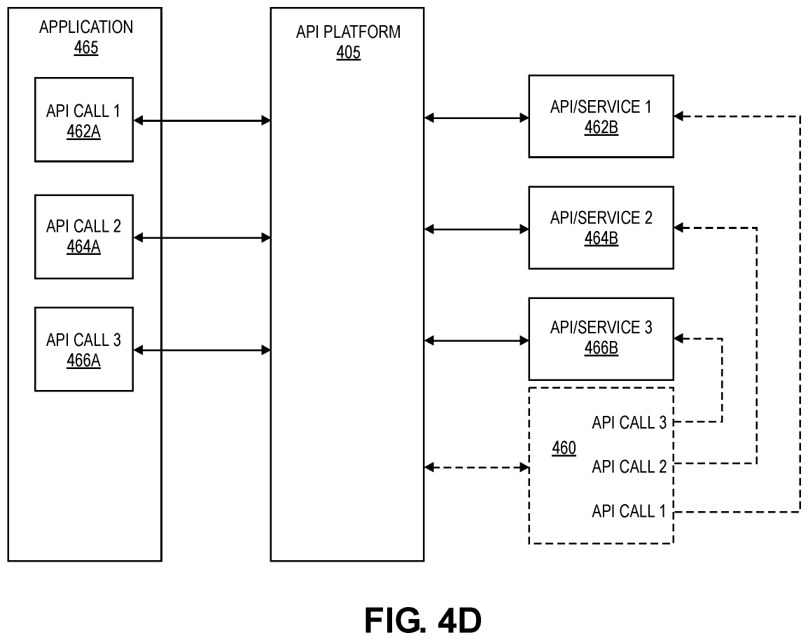

FIG. 4A is an example workflow block diagram 400 for generating the optimized API, in accordance with embodiments described herein. The example workflow block diagram 400 generally illustrates an API platform 405 executable as a set of computer-executable instructions stored on the one or more memories and executed by one or more processors to receive one or more inputs to generate one or more outputs, for example the API platform 128 stored on the memory 124 and executed by the processor 120. The API platform 405 may include, and/or operate in conjunction with, one more components such an LLM 415 (e.g., LLM 144), a GAIM 415 (e.g., GAIM 146), GraphQL 425 for generating the optimized API 416 as illustrated in FIG. 4, although any other suitable component(s) may be used for generating the optimized API 416, according to the systems and methods disclosed herein.

At a first time frame 430, the input the API platform 405 may include an API call data stream 402, and the API platform 405 may output user-specific transaction data 404. The inputs/outputs of the API platform 405 at the first time frame 430 may generally represent the API platform 405 (i) obtaining the API call data stream 402 of one or more API calls from a user device (e.g., user devices 115, 215) to one or more APIs (e.g., APIs 130) supported and/or provided by the API platform 405; (ii) analyzing the API call data stream 402 (e.g., via the LLM 415); and (iii) generating user-specific API transaction data 404 corresponding to the one or more API calls. In some aspects, the API platform 405 may obtain the API call data stream 402 by monitoring API traffic of API calls from the user device to the APIs, retrieving the API call stream data 402 from a memory (e.g., memory 124 and/or databases 132), and/or in any other suitable manner.

At a second time frame 432, the API platform 405 may receive as inputs API data 406 associated with APIs of the API platform 405 and the API generation criteria 408, along with the user-specific API transaction data 404 output at first time frame 430. The API platform 405 may output a beta API 412. The input(s) of the API platform 405 at the second time frame 432 may generally represent the API platform 405 providing the user-specific API transaction data 404, the API data 406, and the API generation criteria 408 as inputs to the GAIM 420, which may include the LLM 415 and/or GraphQL 425 (e.g., to process text associated with of the input data 406, 408 and/or generate the code for the beta API 412). The output of the API platform 405 at the second time frame 432 may generally include the beta API 412. The API platform 405 may receive/obtain the API data 406 may from memory, such as the database 132, etc. The API platform 405 may receive/obtain the API generation criteria 408 from a user device communicatively coupled to the API platform 405 (e.g., via a network such as network 110).

At a third time frame 434, the API platform 405 may receive as an input historical API traffic data 414 along with the beta API 412 generated at second time frame 432, and output the optimized API 416. The inputs/outputs of the API platform 405 at the third time frame 434 may generally represent the API platform 405 configuring and/or testing the beta API 412 using the historical API traffic data 414 via the GAIM 420 to generate the optimized API 416. Testing and/or configuring the optimized API 416 may include the LLM 415 and/or GraphQL 425, e.g., to process text associated with of the historical API traffic 414 and/or generate the code for configuring the beta API 412. The API platform 405 may obtain the historical API traffic data 414 from a memory such as database 132. Once generated, the API platform 405 may update the API platform 405 to implement the optimized API 461, wherein the API platform 405 is configured to receive and respond to calls from one or more client devices, as previously described.

Of course, it should be understood that the inputs and/or outputs illustrated in FIG. 4A are for the purposes of discussion only and may not represent and/or include every input/output.

In one example to illustrate workflow block diagram 400, the API platform 405 may monitor the API call data stream 402 between a smartphone running a mobile weather application (weather app) making two API calls to the API platform 405. The API platform 405 may analyze the API call data stream 402 to generate the user-specific transaction data 404 corresponding to the API calls of the mobile weather app. The user-specific transaction data 404 may indicate the weather app is calling two separate services provided by the APIs of the API platform 405. The first API call to the first API/service indicates an exchange of data corresponding to a weekly weather forecast based upon the weather app providing a location, and the second API call to the second API/service indicates an exchange of data corresponding to historical weather information based upon the weather app providing a location and date. The API platform 405 may obtain from a database the API data 406 of at least APIs/services being called by the weather app as indicated by the user-specific transaction data 404. The API platform 405 may provide the user-specific transaction data 404 and the API data 406 to the GAIM 420 as inputs. The GAIM 420 may generate based upon the user-specific transaction data 404 and the API data 406, a single, beta weather API 412 which includes the functionality of, and is based upon, both the first and second APIs. The GAIM 420 may include the LLM 415 and/or GraphQL 425 to analyze the input data, generate the code of the beta weather API 412, etc.

Once the API platform 405 generates the beta weather API 412 via the GAIM 420, the API platform 405 may further configure and/or test the beta weather API 412, which may include using historical API traffic 414 between the weather app and the first and second APIs/services. For example, the beta weather API 412 may be tested to determine whether it provides the same response data as the original two APIs/services on which the beta weather API 412 is based. The code of the beta weather API 412 may be edited to include security credentials associated with the user of the weather app. The API platform 405 may configure and/or test the beta weather API 412 until one or more tests achieve at least a metric, such as a confidence score. Once one or more metrics of one or more tests are achieved, the beta weather API 412 may be configured as the optimized weather API 416. The optimized weather API 416 may be made available for use by the weather app via the API platform 405, e.g., when updating the API platform 405 to implement the optimized weather API 416, wherein the API platform 405 is configured to receive and respond to calls from one or more client devices. This may include storing the optimized weather API 416 to a database of APIs of the API platform 405.

In at least some aspects, generating the optimized API 416 may take place in the background and/or without any user intervention. For example, an organization offering APIs via the API platform 405 may configure the API platform 405 to optimize existing APIs (e.g., APIs 130) at one or more times to reduce the number of APIs the API platform 405 supports. This may provide benefits for the API platform 405, APIs, end user of the APIs and/or provider of the APIs, such as, but not limited to, an increase in available memory when removing and/or deleting APIs from memory which are no longer needed in light of the creation of one or more optimized APIs; enhancing, improving and/or streamlining the operational characteristics of one or more APIs when creating a new, optimized API and/or optimizing existing APIs, which may result in increased speed of API calls, an improved user experience, etc.; eliminating the need for an API developer to spend time, money and/or resources to create an API which the API platform 405 may otherwise create, and/or any other suitable benefit. When the optimized API 416 is generated, the API platform 405 may inform a user of the optimized API 416, such as via new data/documentation associated with the optimized API 416, a notification (e.g., via a user interface of the API platform, an email, etc.), and/or other suitable method of informing the user.

In at least some aspects, generating the optimized API 416 may include receiving the API generation criteria 408. In one example, a developer of APIs supported by the API platform 405 may require a new API which potentially includes overlapping functionality with one or more existing APIs, such as APIs 130. Rather than create a user-generated API or manually review the available APIs in an attempt to find one or more which may suit their needs, the developer may prefer to provide the API generation criteria 408 to the API platform 405 which indicates operation characteristics they would like an optimized API to include.

FIGS. 4B, 4C, and 4D illustrate (i) an example UI 440 of the API platform 405 to request an optimized API 416, (ii) an example wireframe 450 for providing the API generation criteria 408 to the API platform 405, and (iii) an example block diagram of the optimized API 416 the API platform 405 generates (hereinafter referred to as the developer's API 460), respectively. Although FIGS. 4B-D depict certain UIs, wireframes, APIs, components, equipment, and/or devices, it should be appreciated that these are for ease of illustration only, and additional or alternate UIs, wireframes, APIs, components, equipment, and/or devices are envisioned.

In some embodiments, the API platform 405 may generate the UI 440, for example to allow a software developer (developer) to request the developer's API 460, provide API generation criteria 408 to the API platform 405, request, view and/or download code associated with the developer's API 460, etc.

As illustrated by the example UI 440 of FIG. 4B, the API platform 405 generates the UI 440 which a laptop executing the API platform client application displays on a screen 442 for the developer, such as user device 215 having display 240 executing API platform client application 266. The UI 440 allows the developer to upload the sample wireframe 450 to the API platform 405 for analysis, e.g., to determine the API generation criteria 408 of the wireframe 450. By uploading the sample wireframe 450, the developer requests the developer's API 460 based up the API generation criteria 408 associated with the wireframe 450.

Turning to the example wireframe 450 of FIG. 4C, the wireframe 450 may be and/or include a data file (e.g., stored on the memory of the laptop, such as data storage 262) including hypertext markup language (HTML) code indicating at least some of the API generation criteria 408 of the developer's API 460, such as an action 452, a method 454, and an input 456. Once the developer uploads the wireframe 450 via the UI 440 to the API platform 405, the API platform 405 may analyze the wireframe 450 to determine the action 452, method 454, and input 456 of the API generation criteria 408. Although FIGS. 4B and 4C illustrate uploading the wireframe 450 via the UI 440 to the API platform 405 to obtain the API generation criteria 408 of the developer's API 460, the API platform 405 may obtain the API generation criteria 408 in other ways, such as via the developer answering one or more questions associated with the API generation criteria 408, the developer filling out a form associated with the API generation criteria 408, and/or in any other suitable manner.

Once the API platform 405 obtains the API generation criteria 408, it may generate the developer's API 460 based upon the user-specific transaction data 404, API data 406, and API generation criteria 408. The API platform 405 may determine whether one or more existing APIs satisfy at least a portion of the API generation criteria 408. This may include the API platform 405 determining whether the operational characteristics of one or more existing APIs as indicated by the API data 406 correlate to and/or satisfy the API generation criteria 408.

In one aspect, the API platform 405 may determine an existing API satisfies the API generation criteria 408 if reconfigured, and after reconfiguring and testing (e.g., at third time frame 434), it generates the optimized API 416. For example, the API platform 405 may reconfigure the security characteristics to those indicated by the API generation criteria 408 and/or user-specific transaction data 404 to generate the developer's API 460.

In one aspect, the API platform 405 may determine that two existing APIs in combination, with additional functionality, satisfy the API generation criteria 408. The API platform 405 may generate the optimized API 416 as a single API based upon the two existing APIs, and having new code extending the functions of the two existing APIs to satisfy all the API generation criteria 408.

FIG. 4D illustrates an example of combining and extending the functionality of two APIs to generate the developer's API 460. In the example, the user-specific transaction data 404 may indicate the application 465 being developed by the developer makes two API calls: a first API call 462A to provide a weather forecast via API/service 1 462B, and a second API call 464A to provide historical weather information via API/service 2 464B, when receiving a location and historical date from the application 465. However, the developer also provides API generation criteria 408 indicating the application 465 should make an API call to generate a weather map as well, which is a feature of the application 465 still in development. The API platform 405 may determine, based upon API data 406 of existing APIs of the API platform 405, that an API/service 3 466B satisfies the weather map criteria 408. The API platform 405 may (i) combine the existing functionality of the two existing APIs/services 462B, 464B into a single developer's API 460 (e.g., at second time frame 432), and (ii) generate new code (e.g., at second time frame 432) to provide the weather map function via API/service 3 466B to generate the beta API 412. The API platform 405 may configure and test the beta API 412 (e.g., at third time frame 434) to include credentials associated with the developer and until the beat API 412 attains a specific confidence score respectively, to produce the developer's API 460. The developer's API 460 is optimized as a single API 460 which the application 465 may call to access all 3 services 462B, 464B, 464C as indicated by the dotted lines, rather than making separate API calls to the three individual services 462B, 464B, 466B. The API platform 405 may make the developer's API 460 available to the developer for execution, e.g., when updating the API platform 405 to implement the developer's API 460, such that API platform 405 is configured to receive and respond to calls from one or more client devices to the developer's API 460. This may include the API platform 405 storing the developer's API 460 to a database of APIs supported by the API platform 405.

While the embodiments, aspects, and/or examples illustrated described above indicate that the user-specific transaction data 404, the API data 406, and the API generation criteria 408 may be used as inputs to the API platform 405 to generate the optimized API 416, there may be embodiments, aspects, and/or examples in which fewer inputs may allow the API platform 405 to generate the optimized API 416. In one example, the API generation criteria 408 may not be required as an input when the API platform 405 is operating as a background service optimizing the APIs supported by the API platform 405 without user intervention based upon the user-specific transaction data 404 and the API data 406, as previously described. In one example, the user-specific transaction data 404 may not be required as an input, and the API platform 405 may generate an optimized API based upon the API data 406 and the API generation criteria 408, e.g., to determine whether one or more existing APIs (e.g., APIs 130) satisfy the API generation criteria 408; whether one or more exiting APIs may be reconfigured (e.g., extending functionality, reconfiguring existing operational characteristics, etc.) to satisfy the API generation criteria 408; whether no existing APIs satisfy the API generation criteria 408 and the API platform may generate an optimized API 416 which does satisfy the API generation criteria 408; and/or other suitable situation where the user-specific transaction data 404 may not be required as an input to the API platform 405 to generate the optimized API. The disclosed systems, methods and techniques may include other embodiments, aspects, and/or examples in which fewer inputs may allow the API platform 405 to generate the optimized API 416.

### Exemplary Method for Dynamically Generating Optimized Apis

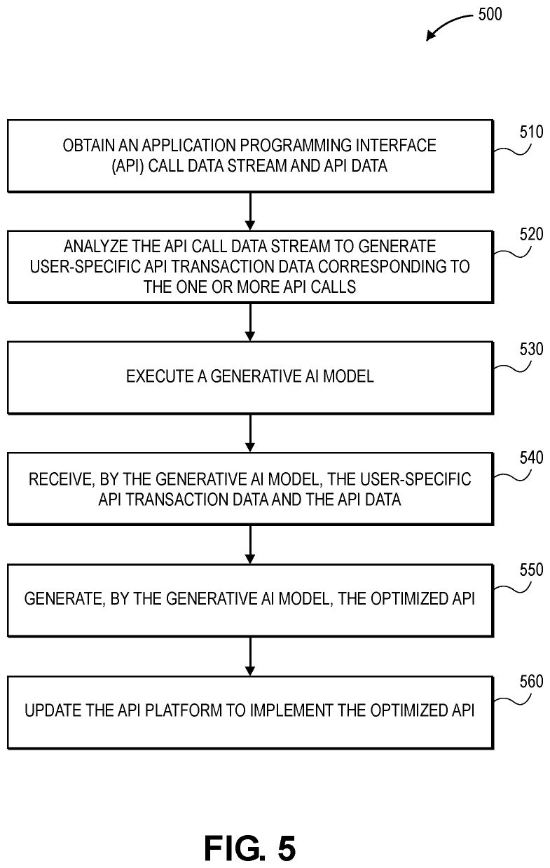

FIG. 5 depicts a flow diagram of an exemplary computer-implemented method 500 for dynamically generating optimized APIs using AI. One or more steps of the method 500 may be implemented as a set of instructions stored on a computer-readable memory and executable on one or more processors. The method 500 of FIG. 5 may be implemented via one or more local or remote processors such as processor 120, servers such as server 105, systems such as computing environment 100, and/or other electronic or electrical components, which may be in wired or wireless communication with one another.

The computer-implemented method 500 may include obtaining, by one or more processors, an API call data stream of one or more API calls from a user device to a plurality of APIs of an API platform (e.g., API platform 128, 405), and API data indicating one or more operational characteristics of one or more APIs of the plurality of APIs (block 510). The API data may include one or more of a method, a function, an endpoint, an action, a request parameter, a data format, a use case, a security characteristic, or a response.

The computer-implemented method 500 may include analyzing, by the one or more processors, the API call data stream to generate user-specific API transaction data corresponding to the one or more API calls (block 520). The user-specific API transaction data may indicate information exchanged between the user device and the plurality of APIs during the one or more API calls. The user-specific API transaction data may include one or more of API request data, API response data, an API transaction type, or an API method.

The computer-implemented method 500 may include executing, by the one or more processors, a GAIM (block 530). The GAIM may be trained using training data to generate an optimized API having at least a portion of the one or more operational characteristics of the one or more APIs. The training data may include historical transaction data and historical API data. The GAIM may include an LLM and/or GraphQL.

The computer-implemented method 500 may cause the GAIM to receive the user-specific API transaction data and the API data (block 540).

The computer-implemented method 500 may cause the GAIM to generate, based upon the user-specific API transaction data and the API data, the optimized API (block 550). In at least some aspects of the computer-implemented method 500, the optimized API may be based upon the one or more APIs, and may include one or more new functions not provided by the one or more APIs, and/or one or more reconfigured functions of the one or more APIs. In at least some aspects, the computer-implemented method 500 may include receiving, by the one or more processors from the user device, API generation criteria indicating the one or more operational characteristics of the optimized API, wherein executing the generative AI model to generate the optimized API (block 550) is further based upon the user API generation criteria.

The computer-implemented method 500 may include updating, by the one or more processors, the API platform to implement the optimized API, wherein the API platform is configured to receive and respond to calls from one or more client devices (block 560). In at least some aspects, the computer-implemented method 500 may include executing, by the one or more processors, one or more tests of the optimized API using historical API traffic data, wherein the optimized API is configured for execution (block 560) based upon the optimized API achieving at least a metric during the one or more tests.

In at least some aspects, the computer-implemented method 500 may include receiving, by the one or more processors from the user device, a request for code of the optimized API, and providing, buy the one or more processor to the user device, the code of the optimized API.

It should be understood that not all blocks of the exemplary flow diagram 500 are required to be performed.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some exemplary embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed:

1. An artificial intelligence (AI) based system for dynamically generating optimized application programming interfaces (APIs), the system comprising:
an API database storing API data of a plurality of APIs of an API platform, the API data indicating one or more operational characteristics of one or more APIs of the plurality of APIs;
a generative AI model stored on one or more memories and executable by one or more processors, the generative AI model trained using training data to generate an optimized API having at least a portion of the one or more operational characteristics of the one or more APIs; and
a set of computer-executable instructions stored on the one or more memories that when executed by the one or more processors cause the one or more processors to:
obtain an API call data stream of one or more API calls from a user device to the plurality of APIs;
analyze the API call data stream to generate user-specific API transaction data corresponding to the one or more API calls, the user-specific API transaction data indicating information exchanged between the user device and the plurality of APIs during the one or more API calls;
execute the generative AI model to:
receive the user-specific API transaction data and the API data; and
generate, based on the API transaction data and the API data, the optimized API; and
update the API platform to implement the optimized API, wherein the API platform is configured to receive and respond to calls from one or more client devices.

2. The system of claim 1, wherein the API data includes one or more of a method, a function, an endpoint, an action, a request parameter, a data format, a use case, a security characteristic, or a response.

3. The system of claim 1, wherein the training data includes historical transaction data and historical API data.

4. The system of claim 3, wherein the historical transaction data and/or historical API data is defined by one or more API class types.

5. The system of claim 1, wherein the generative AI model includes a large language model.

6. The system of claim 1, wherein the generative AI model includes GraphQL.

7. The system of claim 1, wherein the optimized API is based upon the one or more APIs and includes one or more of:
one or more new functions not provided by the one or more APIs; or
one or more reconfigured functions of the one or more APIs.

8. The system of claim 1, further comprising stored instructions that, when executed by the one or more processors, further cause the system to:
execute one or more tests of the optimized API using historical API traffic data, wherein the optimized API is configured for execution based upon the optimized API achieving at least a metric during the one or more tests.

9. The system of claim 1, further comprising stored instructions that, when executed by the one or more processors, further cause the system to:
receive, from the user device, API generation criteria indicating the one or more operational characteristics of the optimized API, wherein executing the generative AI model to generate the optimized API is further based upon the user API generation criteria.

10. The system of claim 1, further comprising stored instructions that, when executed by the one or more processors, further cause the system to:
receive, from the user device, a request for code of the optimized API; and
provide, to the user device, the code of the optimized API.

11. The system of claim 1, wherein the user-specific API transaction data includes one or more of API request data, API response data, an API transaction type, or an API method.

12. A computer-implemented method for dynamically generating optimized application programming interfaces (APIs), the method comprising:
obtaining, by one or more processors, an API call data stream of one or more API calls from a user device to a plurality of APIs of an API platform, and API data indicating one or more operational characteristics of one or more APIs of the plurality of APIs;
analyzing, by the one or more processors, the API call data stream to generate user-specific API transaction data corresponding to the one or more API calls, the user-specific API transaction data indicating information exchanged between the user device and the plurality of APIs during the one or more API calls;
executing, by the one or more processors, a generative AI model trained using training data to generate an optimized API having at least a portion of the one or more operational characteristics of the one or more APIs, causing the generative AI model to:
receive the user-specific API transaction data and the API data; and
generate, based on the API transaction data and the API data, the optimized API; and
updating, by the one or more processors, the API platform to implement the optimized API, wherein the API platform is configured to receive and respond to calls from one or more client devices.

13. The computer-implemented method of claim 12, wherein the API data includes one or more of a method, a function, an endpoint, an action, a request parameter, a data format, a use case, a security characteristic, or a response.

14. The computer-implemented method of claim 12, wherein the training data includes historical transaction data and historical API data.

15. The computer-implemented method of claim 14, wherein the historical transaction data and/or historical API data is defined by one or more API class types.

16. The computer-implemented method of claim 12, wherein the generative AI model includes a large language model.

17. The computer-implemented method of claim 12, wherein the generative AI model includes GraphQL.

18. The computer-implemented method of claim 12, wherein the optimized API is based upon the one or more APIs and includes one or more of:
one or more new functions not provided by the one or more APIs; or
one or more reconfigured functions of the one or more APIs.

19. The computer-implemented method of claim 12, further comprising:
executing, by the one or more processors, one or more tests of the optimized API using historical API traffic data, wherein the optimized API is configured for execution based upon the optimized API achieving at least a metric during the one or more tests.

20. The computer-implemented method of claim 12, further comprising:
receiving, by the one or more processors from the user device, API generation criteria indicating the one or more operational characteristics of the optimized API, wherein executing the generative AI model to generate the optimized API is further based upon the user API generation criteria.

21. The computer-implemented method of claim 12, wherein the user-specific API transaction data includes one or more of API request data, API response data, an API transaction type, or an API method.

22. A non-transitory computer-readable medium storing processor-executable instructions for dynamically generating optimized application programming interfaces (APIs), the instructions that, when executed by one or more processors, cause the one or more processors to at least:
obtain API call data stream of one or more API calls from a user device to a plurality of APIs of an API platform, and API data indicating one or more operational characteristics of one or more APIs of the plurality of APIs;
analyze the API call data stream to generate user-specific API transaction data corresponding to the one or more API calls, the user-specific API transaction data indicating information exchanged between the user device and the plurality of APIs during the one or more API calls;
execute a generative AI model trained using training data to generate an optimized API having at least a portion of the one or more operational characteristics of the one or more APIs, causing the generative AI model to:
receive the user-specific API transaction data and the API data; and
generate, based on the API transaction data and the API data, the optimized API; and
update the API platform to implement the optimized API, wherein the API platform is configured to receive and respond to calls from one or more client devices.
